(19) United States
(12) Patent Application Publication
(10) Pub. No.: US 2016/0239848 A1
(43) Pub. Date: Aug. 18, 2016

(54) METHOD AND SYSTEM FOR AUTOMATIC EXECUTION OF AT LEAST ONE NEXT ACTION DURING A CUSTOMER INTERACTION

(71) Applicant: 24/7 Customer, Inc., Campbell, CA (US)

(72) Inventors: Andrew Liang Ping CHANG, Palo Alto, CA (US); Michael BODELL, Santa Clara, CA (US); Kathy L. BROWN, San Ramon, CA (US); Michael MONEGAN, Los Osos, CA (US)

(21) Appl. No.: 15/042,100

(22) Filed: Feb. 11, 2016

Related U.S. Application Data
(60) Provisional application No. 62/116,251, filed on Feb. 13, 2015.

(51) Int. Cl. G06Q 30/00

(52) U.S. Cl. CPC G06Q 30/016

(57) ABSTRACT

A computer-implemented method and an apparatus for automatic execution of at least one next action during a customer interaction receives current information related to a customer from at least one device associated with the customer. At least one next action is determined for the customer in response to the received current information. The at least one next action is determined based on the current information and stored past information corresponding to the customer. Further, an automatic execution of the at least one next action is effected on behalf of the customer if the at least one next action satisfies one or more predefined criteria. The at least one next action is executed on a device from among the at least one device associated with the customer.

### CROSS REFERENCE TO RELATED APPLICATIONS

This application claims priority to U.S. provisional patent application Ser. No. 62/116,251, filed Feb. 13, 2015, which is incorporated herein in its entirety by this reference thereto.

### TECHNICAL FIELD

The invention generally relates to automatic execution of at least one next action during a customer interaction.

### BACKGROUND

Customers typically contact customer support representatives (or agents) of an enterprise for a variety of purposes, such as for example, to enquire about a product or a service, to seek answers to their queries, to make payments, to resolve their concerns, to lodge complaints etc.

More often than not, the customers have to wait for a long time to connect to an agent, and once connected, the interactions follow a prescribed path as the interactions with the agents are generally based on scripts or menus. From the perspective of the customers, scripted support experiences can be very frustrating and can lead to the customers exiting the interactions.

Current solutions of providing customer service and/or support are counterintuitive and require customers to seek help and endure frustrating scripted interactions, thereby degrading a quality of customer experiences and resulting in operating losses for the enterprises. Moreover, the current solutions lack the ability to take action on behalf of the customer to solve customer issues.

Accordingly, there is a need to anticipate customer actions and provision services in an intuitive manner to improve customer experiences.

### SUMMARY

In an embodiment of the invention, a computer-implemented method for automatic execution of at least one next action during a customer interaction is disclosed. The method receives, by a processor, current information related to a customer from at least one device associated with the customer. The method determines, by the processor, at least one next action for the customer in response to the received current information. The at least one next action is determined based on the current information and stored past information corresponding to the customer. The method effects, by the processor, an automatic execution of the at least one next action on behalf of the customer if the at least one next action satisfies one or more predefined criteria. The at least one next action is executed on a device from among the at least one device associated with the customer.

In another embodiment of the invention, a system for automatic execution of at least one next action during a customer interaction includes at least one processor and a memory. The memory stores machine executable instructions therein, that when executed by the at least one processor, causes the system to receive current information related to a customer from at least one device associated with the customer. The system determines at least one next action for the customer in response to the received current information. The at least one next action is determined based on the current information and stored past information corresponding to the customer. The system effects an automatic execution of the at least one next action on behalf of the customer if the at least one next action satisfies one or more predefined criteria. The at least one next action is executed on a device from among the at least one device associated with the customer.

In another embodiment of the invention, a non-transitory computer-readable medium storing a set of instructions that when executed cause a computer to perform a method for automatic execution of at least one next action during a customer interaction is disclosed. The method executed by the computer receives current information related to a customer from at least one device associated with the customer. The method determines at least one next action for the customer in response to the received current information. The at least one next action is determined based on the current information and stored past information corresponding to the customer. The method effects an automatic execution of the at least one next action on behalf of the customer if the at least one next action satisfies one or more predefined criteria. The at least one next action is executed on a device from among the at least one device associated with the customer.

### BRIEF DESCRIPTION OF THE FIGURES

FIG. 1 shows an example representation of a customer engaging in a voice call interaction with an agent associated with an enterprise, in accordance with an example scenario;

FIG. 2 is a block diagram of a system configured to effect an improvement in experiences of customers of an enterprise, in accordance with an embodiment of the invention;

FIG. 3 shows an email notification provided to a customer by the system of FIG. 2 subsequent to effecting an automatic execution of a next action for the customer, in accordance with an embodiment of the invention; and

FIG. 4 shows an example user interface (UI) displayed to a customer on a device of the customer for seeking a customer approval for effecting an automatic execution of a determined best next action, in accordance with an embodiment of the invention;

FIG. 5 shows a UI displayed to a customer on a customer's device for illustrating an example execution of a best next action, in accordance with an embodiment of the invention;

FIG. 6 shows an example recommendation provided to a customer on an enterprise website, in accordance with an embodiment of the invention;

FIG. 7 shows a UI displaying automatic uploading of a customer's credit card credentials for completing a purchase, in accordance with an embodiment of the invention; and

FIG. 8 is a flow diagram of an example method for improving an experience of a customer, in accordance with an embodiment of the invention.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples.

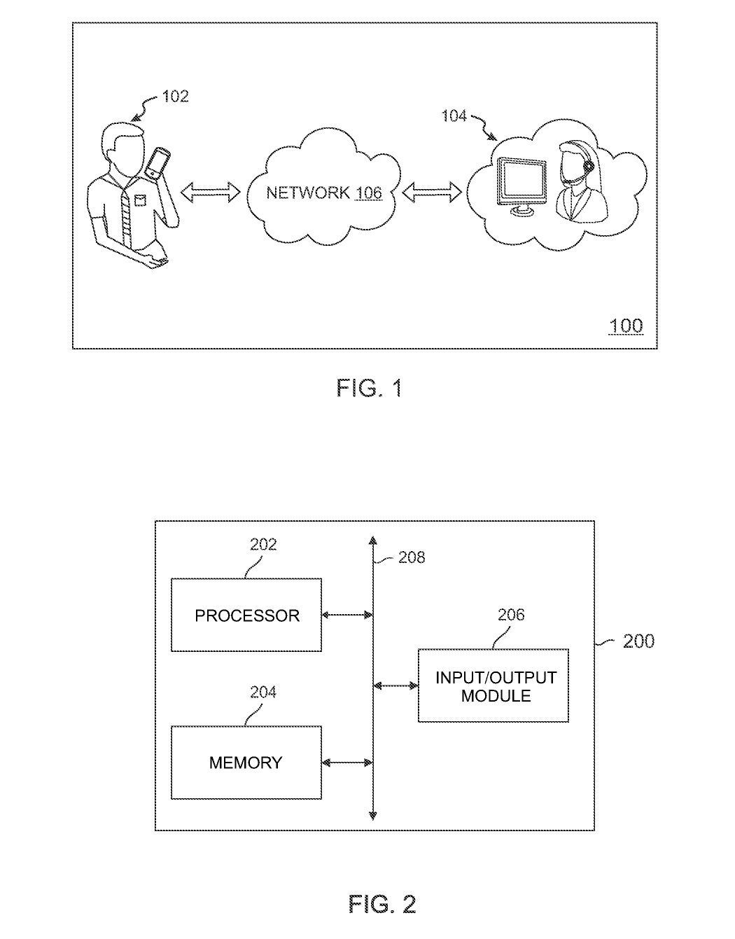

FIG. 1 shows an example representation 100 of a customer 102 engaging in a voice call interaction with an agent 104 associated with an enterprise, in accordance with an example scenario. The term ‘enterprise’ as used herein may refer to a corporation, an institution, a small/medium sized company or even a brick and mortar entity. For example, the enterprise may be a banking enterprise, an educational institution, a financial trading enterprise, an aviation company, a consumer goods enterprise or any such public or private sector enterprise. It is understood that the enterprise may be associated with a plurality of customers, such as the customer 102.

Typically, most enterprises apart from seeking to successfully fulfill needs of potential and existing customers, also aspire to provide their customers with an effortless interaction experience. To that effect, many enterprises deploy customer support centers including human and virtual agents (i.e. customer support representatives) to provide sales and service support to their customers. The customers may initiate interaction with the agents for a variety of purposes, such as for example, to enquire about billing or payment, to configure a produce or troubleshoot an issue related to a product, to enquire about upgrades, to enquire about shipping of the product/service, to provide feedback, to register a complaint, to follow up about a previous query and the like. Each customer may utilize one or more respective personal devices to engage in an interaction with an agent. For example, in the example representation 100, the customer 102 is depicted to utilize a mobile phone to engage in a voice call interaction with the agent 104. In some embodiments, the customer 102 may utilize interaction channels other than the voice channel for interacting with an agent. For example, the customer 102 may utilize a personal computer (or a laptop or any web-connected device) to engage in a text based interaction, such as a chat interaction (i.e. a chat channel) or an email interaction (i.e. an email channel) with the agent 104. In some embodiments, the customer 102 may visit a website (i.e. use a web channel) of the enterprise to make an enquiry for a recent purchase or troubleshoot an issue related to a product. It is understood that one or more of such interaction channels may be accessed using a network, such as a network 106. Examples of the network 106 may include wired networks, wireless networks or a combination thereof. Examples of wired networks may include Ethernet, local area networks (LAN), fiber-optic cable networks and the like. Examples of wireless network may include cellular networks like GSM/3G/4G/CDMA based networks, wireless LANs, Bluetooth or Zigbee networks and the like. An example of a combination of wired and wireless networks may include the Internet.

Accordingly, the customers, such as the customer 102, may utilize one or more personal devices and one or more interaction channels to engage in interactions with agents of the enterprise. However, more often than not, the customers have to wait for a long time to connect to an agent, and once connected, the interactions follow a prescribed path as the interactions with the agents are based on scripts or menus. From the perspective of the customers, scripted support experiences can be very frustrating and can lead to the customers exiting the interactions. For example, a customer contacting a helpline associated with an enterprise for a computer that does not power ON may be told to check the power plug. While this information may be useful to a novice computer user, an expert user calling in with a request indicating need for replacement may be frustrated or worse, may feel insulted. In such a scenario, the customer may exit the interaction and, perhaps never engage with the enterprise again. In another example scenario, a customer having booked a flight trip through an enterprise portal may need further assistance as the flight reservation was canceled. In such a scenario, the customer may need to engage with the enterprise portal again and/or interact with the agent to rebook the flight trip.

Current solutions of providing customer service and/or support are counterintuitive and require customers to seek help and endure frustrating scripted interactions, thereby degrading a quality of customer experiences and resulting in operating losses for the enterprises. Moreover, the current solutions lack the ability to take action on behalf of the customer to solve customer issues. Accordingly, there is a need to anticipate customer actions and provision services in an intuitive manner to improve customer experiences.

Various embodiments of the present technology provide systems and methods that are capable of overcoming these and other obstacles and providing additional benefits. More specifically, systems and methods disclosed herein suggest techniques for predicting at least one next action for a customer and effecting an automatic execution of the best next action in order to improve customer experiences. An example system configured to effect improvement in customer experiences is explained with reference to FIG. 2.

FIG. 2 is a block diagram of a system 200 configured to effect an improvement in experiences of customers of an enterprise, in accordance with an embodiment of the invention. As explained with reference to FIG. 1, the term ‘enterprise’ may refer to a corporation, an institution, a small/medium sized company or even a brick and mortar entity. For example, the enterprise may be a banking enterprise, an educational institution, a financial trading enterprise, an aviation company, a consumer goods enterprise or any such public or private sector enterprise. Further, the term ‘customers’ as used herein includes both existing and potential users of products, services or information offered by the enterprise. Furthermore, the term ‘improving customer experiences’ as used herein refers to enabling the customers to achieve their respective objectives in an efficient and hassle-free manner without requiring the customers to seek help or engage in scripted interactions with agents of the enterprise.

The system 200 includes at least one processor, such as a processor 202 and a memory 204. It is noted that although the system 200 is depicted to include only one processor, the system 200 may include more processors therein. In an embodiment, the memory 204 is capable of storing machine executable instructions. Further, the processor 202 is capable of executing the stored machine executable instructions. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed.

The memory 204 may be embodied as one or more volatile memory devices, one or more non-volatile memory devices, and/or a combination of one or more volatile memory devices and non-volatile memory devices. For example, the memory 204 may be embodied as magnetic storage devices (such as hard disk drives, floppy disks, magnetic tapes, etc.), optical magnetic storage devices (e.g. magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

The system 200 also includes an input/output module 206 (hereinafter referred to as ‘I/O module 206’) for providing an output and/or receiving an input. The I/O module 206 is configured to be in communication with the processor 202 and the memory 204. Examples of the I/O module 206 include, but are not limited to, an input interface and/or an output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, a vibrator, and the like. In an example embodiment, the processor 202 may include I/O circuitry configured to control at least some functions of one or more elements of the I/O module 206, such as, for example, a speaker, a microphone, a display, and/or the like. The processor 202 and/or the I/O circuitry may be configured to control one or more functions of the one or more elements of the I/O module 206 through computer program instructions, for example, software and/or firmware, stored on a memory, for example, the memory 204, and/or the like, accessible to the processor 202.

In an embodiment, the I/O module 206 may be configured to provide a user interface (UI) configured to enable enterprises to utilize the system 200 for effecting improvement in experiences of respective customers. Furthermore, the I/O module 206 may be integrated with a monitoring mechanism configured to provide the enterprise users with real-time updates/alerts (for example, email notifications, SMS alerts, etc.) of changes to be made for efficiently addressing customer requirements.

In an embodiment, various components of the system 200, such as the processor 202, the memory 204 and the I/O module 206 are configured to communicate with each other via or through a centralized circuit system 208. The centralized circuit system 208 may be various devices configured to, among other things, provide or enable communication between the components (202-206) of the system 200. In certain embodiments, the centralized circuit system 208 may be a central printed circuit board (PCB) such as a motherboard, a main board, a system board, or a logic board. The centralized circuit system 208 may also, or alternatively, include other printed circuit assemblies (PCAs) or communication channel media.

It is understood that the system 200 as illustrated and hereinafter described is merely illustrative of a system that could benefit from embodiments of the invention and, therefore, should not be taken to limit the scope of the invention. It is noted that the system 200 may include fewer or more components than those depicted in FIG. 2. Moreover, the system 200 may be implemented as a centralized system, or, alternatively, the various components of the system 200 may be deployed in a distributed manner while being operatively coupled to each other. In another embodiment, the system 200 may be embodied as a mix of existing open systems, proprietary systems and third party systems. In another embodiment, the system 200 may be implemented completely as a set of software layers on top of existing hardware systems. In an exemplary scenario, the system 200 may be any machine capable of executing a set of instructions (sequential and/or otherwise) so as to improve experiences of customers.

In an embodiment, the I/O module 206 may include one or more transceivers configured to facilitate to and fro communication with application programming interfaces (APIs) of personal devices of customers and remote data gathering servers. In at least one example embodiment, the I/O module 206 may also be configured to effect execution of one or more actions on personal devices of the customers by communicating with the APIs included in the personal devices of the customers, as will be explained later. In at least one example embodiment, the I/O module 206 may be configured to receive information related to a plurality of customers of one or more enterprises from the remote data gathering servers.

In an embodiment, the remote data gathering servers may collate information from a plurality of interaction channels and/or a plurality of devices accessed by the customers for interacting with an enterprise. To that effect, the remote data gathering servers may be in operative communication with various customer touch points, such as the electronic devices associated with the customers, the websites visited by the customers, the customer support representatives (for example, voice-agents, chat-agents, IVR systems and the like) engaged by the customers and the like. For example, the remote data gathering servers may be configured to track website access by customers by way of tracking cookies (for example, web browser cookies) and/or tags, such as hypertext markup language (HTML) tags or JavaScript tags associated with the web pages of the website. In some cases, the remote data gathering servers may also be capable of opening up a socket connection for an on-going customer journey on the website to capture data related to customer activity on the website. The I/O module 206 may be configured to receive information captured in such a manner from the remote data gathering servers.

In an embodiment, the information received by the I/O module 206 corresponding to a customer may include profile data and journey data corresponding to the customer. The profile data may include profile information related to the customer, such as for example, a customer's name, contact details, personal and family information, financial accounts information, information relating to products and services associated with the customer, social media account information, other messaging or sharing platforms used by the customer, recent transactions, customer interests and preferences, customer's credit history, history of bill payments, credit score, memberships, history of travel, and the like. In some exemplary embodiments, the customer information may also include calendar information associated with the customer. For example, the calendar information may include information related to an availability of the customer during the duration of a day, week or month.

In an embodiment, journey data received corresponding to the customer may include information such as web pages visited, queries entered, chat entries, purchases, exit points from websites, decisions made, mobile screens touched, work flow steps completed, sequence of steps taken, engagement time, IVR speech nodes touched, IVR prompts heard, widgets/screens/buttons selected or clicked, historical session experience and their results, customer relationship management (CRM) state and state changes, agent wrap-up notes, speech recordings/transcripts, chat transcripts, survey feedback, channels touched/used, sequence of channels touched/used, instructions, answers, actions given/performed by either enterprise or agents for the customer, and the like. In some example scenarios, the journey data may include information related to past interactions of the customer with resources at a customer support facility, the types of channels used for interactions, customer channel preferences, types of customer issues involved, whether the issues were resolved or not, the frequency of interactions, and the like.

In some example scenarios, the journey data associated with the customer may also include information related to a customer's intention or goal. In an embodiment, the intention can be inferred based on activity or may be specifically indicated by the customer. The journey data can also include information derived from tracking and recording the customer's behavior across a plurality of channels. In at least one embodiment, the journey data may be collected from the time a customer starts envisioning and taking steps to achieve an intention or goal (both within a single channel of interaction or across channels of interactions) to the time a goal is attained, changed, or abandoned. Furthermore, the journey data may further include workflows dictated by an enterprise's processes, policies, procedures, and technologies. These workflows may influence the journey taken or future journeys that could be taken. In an embodiment, the journey data includes information collected based on tracking and recording of the customer's experience caused by the intersection of the customer's behavior and an enterprise workflow.

The I/O module 206 is configured to receive such information related to the customers in real-time or on a periodic basis. Moreover, the information may be received by the I/O module 206 in an online mode or an offline mode. In an embodiment, the I/O module 206 provides the received information to the memory 204 for storage purposes. In an embodiment, the information related to each customer is labeled with some customer identification information (for example, a customer name, a unique ID and the like) prior to storing the information in the memory 204. It is understood that over a period of time such information accumulates for each customer and serves as ‘stored past information’ for the customer. The stored past information corresponding to each customer may be used for improving experiences of respective customers. An improvement in an experience afforded to a customer of an enterprise is explained hereinafter with reference to one customer. It is understood that experiences of several customers of the enterprise may be improved in a similar manner.

In an embodiment, the processor 202 is configured to, with the content of the memory 204, cause the system 200 to receive current information related to a customer from at least one device associated with the customer. The personal devices of the customers are hereinafter individually referred to as a device and collectively as devices. Some non-exhaustive examples of a device may include a mobile phone, a tablet computer, a Smart Phone, a desktop computer, a laptop, a personal digital assistant, a wearable device and the like. As explained above, the I/O module 206 includes one or more transceivers capable of communicating with APIs in the personal devices of the customers. The I/O module 206 may receive current information for a customer from one or more APIs in the devices of the customer. Some non-limiting examples of the received current information related to the customer may include (1) a current location of the customer; (2) web activity information including a log of activity of the customer on one or more websites being currently accessed by the customer; (3) device application information indicative of one or more applications being currently accessed by the customer on one or more devices of the customer; (4) calendar information comprising scheduled itinerary associated with the customer; (5) event occurrence information indicative of occurrence of an event related to the customer; and (6) interaction information including information related to a current interaction between a customer and a customer support representative (i.e. an agent). In an embodiment, the web activity information may include information such as web pages visited, time stamps associated with each web page visit, menu options accessed, drop-downs selected or clicked, mouse movements, hypertext mark-up language (HTML) links those which are clicked and those which are not clicked, focus events (for example, events during which the online visitor has focused on a link/webpage for a more than a predetermined amount of time), non-focus events (for example, choices the online visitor did not make from information presented to him/her (for example, products not selected) or non-viewed content derived from scroll history of the online visitor), touch events (for example, events involving a touch gesture on a touch-sensitive device such as a tablet), non-touch events and the like. Additionally, the I/O module 206 is also configured to receive data related to which device was used (or is being used) by a customer for accessing the website, a web browser and/or an operating system associated with the device used for accessing the website, a time of the day or a day of the week associated with the website visit, and the like. In an embodiment, the event occurrence information may include information related to current events such as for example, a fraudulent charge on a credit card, a car accident involving the customer and/or the customer's vehicle, a canceled appointment, a postponement or a cancellation of a flight, a reminder notice for bill payment that is due, and the like. In an embodiment, the device application information may include information related to native device applications that are currently being utilized such as for example, a frequency of usage, a type of application (for example, a fitness application, an e-commerce application, a flight reservation application etc.), a day/time of accessing the application, and the like. Similarly, the received interaction information may include information such as an agent name, a type of customer concern, whether the concern was resolved or not, time duration of interaction, stages of interaction, interaction transfers if any, and the like.

In an embodiment, the processor 202 is configured to, with the content of the memory 204, cause the system 200 to determine at least one next action for the customer in response to the received current information. The one or more next actions may be determined based on the current information and the stored past information corresponding to the customer. As explained above, the stored past information corresponding to the customer includes profile and journey data corresponding to the customer. More specifically, the stored past information corresponding to the customer is collated from across a plurality of interaction channels previously accessed by the customer for executing a plurality of actions, such as conducting a financial transaction, chatting with an agent, making a travel reservation, etc. Accordingly, the stored past information for a customer may include information such as recent financial transactions, history of bill payments, credit history, travel history, customer memberships, frequently visited websites, customer preferences and historical interactions with customer support representatives etc.

In an embodiment, the system 200 may be caused to retrieve one or more past actions of the customer from the stored past information based on a relevance of the one or more past actions to the current information, and determine at least one next action based on the one or more past actions of the customer. For example, if the current information relates to a meeting cancellation event, then the system 200 may be caused to retrieve previous actions of the customer in response to such an event. For example, the customer may have previously rescheduled the meeting as a web conference and sent invitations to mobile devices of probable attendees based on confirmed availability. Accordingly, the system 200 may be caused to determine the next actions to be rescheduling the meeting as a web conference at a time when the probable attendees are free to attend the meeting and then sending invites to the probable attendees of the web conference.

In some embodiments, the system 200 may be caused to identify relevant actions of customers associated with profiles similar to a profile of the customer and determine the next action based on the identified actions. For example, if the current information relates to a fraudulent card transaction event, then the system 200 may be caused to identify actions of other customers, who have similar profile (for example, similar age, profession, travel preferences, etc.) as that of the customer for such an event and determine one or more next actions based on the identified actions of the other customers. For example, other customers with similar profile as that of the customer may have canceled their credit card and ordered a replacement credit card. Accordingly, the system 200 may be caused to determine the next actions to be cancellation of the card and ordering of a replacement card.

In an embodiment, a next action determined by the system 200 may correspond to at least one of rebooking a flight reservation, paying a bill, making a hotel reservation, making a car rental reservation, making a restaurant reservation, purchasing one or more tickets to an event (such as a game, movie screening, theatrical presentation etc.), purchasing a product, initiating contact with an emergency service provider, seeking technical support, troubleshooting a concern, rescheduling one or more appointments, accessing a map location to search for one or more preferred locations near a current location of the customer and the like. In an embodiment, the next action may relate to a financial transaction, such as an action related to fraud prevention, proactive offer of payment splitting and/or payment rescheduling, credit card cancellation, seeking a replacement credit card and so on and so forth.

In an embodiment, the processor 202 is configured to, with the content of the memory 204, cause the system 200 to effect an automatic execution of at least one next action on behalf of the customer if the at least one next action satisfies one or more predefined criteria. In an embodiment, the I/O module 206 may facilitate automatic execution of the one or more next actions on the device of the customer. The automatic execution of the one or more next actions on the customer device may be facilitated through an application programming interface (API) specific to the customer device and which is in operative communication with the I/O module 206 of the system 200. For example, the API on the customer device could enable data sharing between a location tracking application and a banking application, which could be used for detecting fraudulent transactions. Similarly, embodiments of the invention can enable a change in the GUI of an application based on the time of day.

In an embodiment, the system 200 may be caused to ascertain if the next action to be executed satisfies one or more criteria prior to its automatic execution on the device of the customer. For example, one criterion may relate to a requirement for a next action to be associated with an ability to be reversed upon execution. More specifically, the next action may be automatically executed on the device of the customer only if that action can be undone or reversed. In another illustrative example, a criterion may relate to a requirement for a next action to conform to at least one of a customer selected financial limit and a customer selected time limit if the next action corresponds to a financial transaction. More specifically, the customer may predefine certain limits and authorize actions to be performed if the next action conforms to those limits. For example, a customer selected financial limit may be 500 US dollars indicating that automatic execution of next actions involving financial transactions may only be performed if the amount involved during a transaction is less than or equal to 500 US dollars (and moreover, only if it can be undone). Similarly, a customer selected time limit may be a day or a week indicating that automatic execution of next actions involving financial transactions may only be performed if payment is due within one day time frame or one week time frame. In an embodiment, a criterion may relate to a requirement for a next action to conform to a customer defined (or even system defined) threshold. In an embodiment, the threshold may be implemented as a probability value. For example, only if the determined next action is associated with at least 70% probability of success, then the automatic execution of the action may be effected. In an illustrative example, only if a probability of the next action predicted to be a purchase of a pair of shoes is greater than 0.7 or 70% then the purchase of the pair of shoes through the customer's credit card may be facilitated automatically. In an embodiment, the system 200 may be caused to provide the determined best next action as a service to a third party and in conjunction with the third party effect automatic execution of the best next action. In an embodiment, machine learning may be used to monitor the determination of best next actions and the customer responses to the determined best next actions in order to improve the determinations of the best next actions. As such, the best next action determinations may change over time.

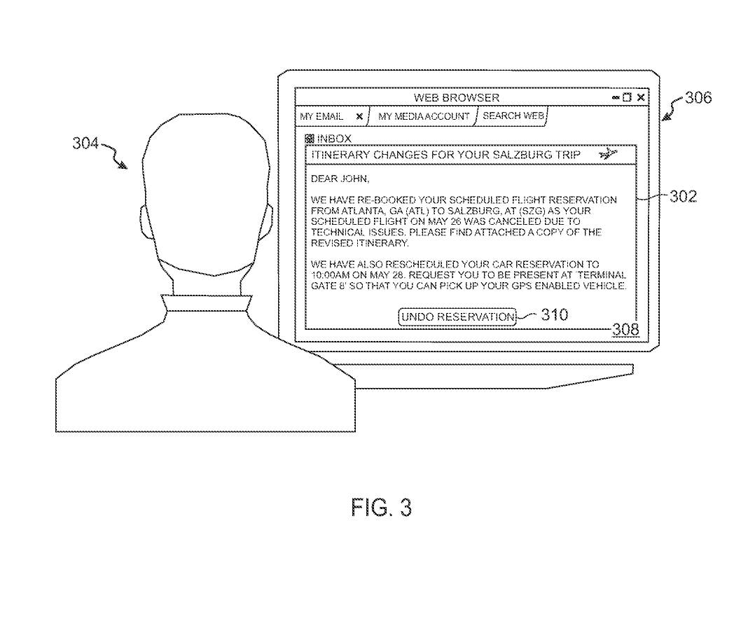

In at least one example embodiment, the system 200 is caused to determine the most suitable next action from among a number of probable actions capable of being performed for the customer in response to the received current information. The most suitable next action (or actions) is also referred to herein as ‘best next action (or best next actions)’. In an embodiment, the system 200 is caused to provision a message on the customer's device for notifying the customer of the automatic execution of the best next action. The provisioning of such a message is depicted in FIG. 3.

Referring now to FIG. 3, an email notification 302 provided to a customer 304 by the system 200 of FIG. 2 subsequent to effecting an automatic execution of a best next action for the customer 304 is shown, in accordance with an embodiment of the invention. In an illustrative example scenario, the customer 304 may have booked a flight trip to an overseas location for a meeting with a client. The scheduled flight on account of a technical issue may have been canceled. The customer 304 may have received an email notification and/or an SMS notification of the cancellation of the flight reservation. The cancellation of the flight reservation may have reflected as a canceled entry in the calendar application in a device 306 of the customer 304. An occurrence of such an event involving a flight reservation cancellation may be received from the customer's device 306 by the I/O module 206. In response to the received current information involving cancellation of a scheduled flight journey, the system 200 may be caused to determine the best next action for the customer 304. Based on the stored past information, in an example scenario, the system 200 may be caused to determine that the flight reservation needs to rebooked. Further, the airport car rental reservation may also need to be changed to match the new flight timings. Accordingly, the best next actions may be determined to be rebooking a flight reservation and rescheduling of a car rental reservation.

In at least one embodiment, the system 200 may be caused to utilize the APIs, such as for example an API for a travel booking application, in the device 306 to effect the automatic execution of the determined best next actions. In an embodiment, the stored past information of the customer 304 may include travel related details such as name, frequent flyer ID, travel preferences, credit card details used for booking the flight etc. The system 200 may be caused to utilize such information to rebook the flight reservation and also reschedule the car rental reservation. In some example embodiments, the system 200 may be caused to facilitate communication with a customer's preferred travel partner (for example, identified from customer's phone contacts) to rebook the flight reservation. In some cases, the communication may be handled be agents, whereas in some cases, the rebooking of the flight reservation may be handled through electronic communication, for example through APIs, as explained above.

As explained with reference to FIG. 2, such next actions may be executed only if they satisfy predefined criteria. For example, the automatic execution of the rebooking of the flight reservation and the rescheduling of the car reservation may only be performed if they can be undone or reversed. In some embodiments, the rebooking or rescheduling actions may be performed only if they do not incur any extra financial charges to the customer 304. Upon automatic execution of the rebooking of the flight reservation, the customer 304 may be provided a message, such as the email notification 302, displayed on a display screen 308 of the device 306 informing the customer 304 of the rebooking of the flight reservation and rescheduling of the car rental reservation.

The email notification 302 also displays a button 310 (displaying text ‘UNDO RESERVATION’) to the customer 304. The customer 304 may provide an instruction to revoke the automatic execution of the actions by providing a click input or a touch input on the button 310. If the customer 304 provides such an input then the automatically executed actions of rebooking the flight reservation and rescheduling of the car rental reservation may be revoked. As can be seen from the illustrative example explained with reference to FIG. 3, customers of an enterprise associated with the system 200, such as the customer 304, may be saved time and effort in rebooking the flight reservation and/or rescheduling the car rental reservation. Moreover, the customers do not need to seek help from an agent or endure frustrating scripted interactions. Accordingly, such determination of best next actions for the customers and the automatic execution of the determined best next actions on their respective devices may substantially improve experiences of the customers.

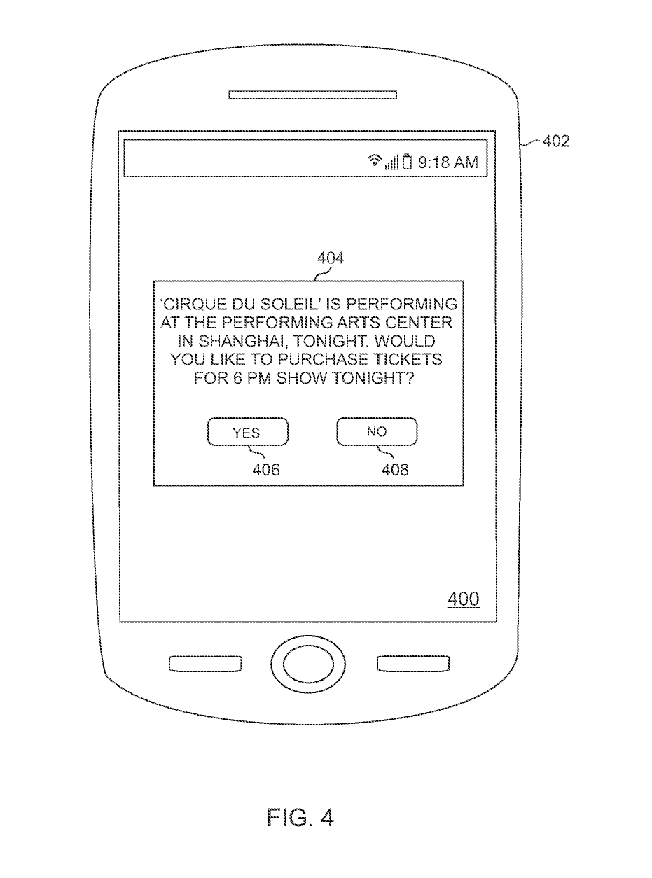

Referring now to FIG. 2, in an example embodiment, the processor 202 is configured to, with the content of the memory 204, cause the system 200 to request an approval from a customer for effecting the automatic execution of at least one next action if the at least one next action does not satisfy one or more predefined criteria. For example, if rebooking of a flight reservation cannot be undone or such a rebooking/rescheduling is not authorized by the customer, then in such an event, the system 200 may be caused to seek approval from the customer prior to automatically executing the best next actions. Upon receiving such an approval, the system 200 may be caused to execute the best next actions on the device of the customer. If the customer rejects the approval, then the best next actions may be precluded from being automatically executed on the device of the customer. In an illustrative example, the information received for a customer may include calendar information including a customer's travel plans from Boston to San Francisco and a busy client appointment schedule. Additionally, the customer may be using an application on a personal device to check the weather forecast for San Francisco. In such a scenario, the determination of the best next action by the system 200 may consider these pieces of current information to determine the best next actions for the customer. Further, the determination of the best next action may involve examining the long-range weather forecast for San Francisco and the travel reservations of the customer. For example, the air travel reservations of the customer may include a layover in Chicago. However, the long-range weather forecast includes a prediction of heavy snow in Chicago on the day of travel. The determination of the best next action in such a case may include recommending to the customer that traveling a day earlier may be prudent and that certain flights are still available. If the customer accepts the recommendation, then the system 200 may be caused to automatically initiate changing the flight reservation, booking an additional night at a hotel, changing a rental vehicle reservation, contacting the client list of the customer, and so on and so forth. As explained above, the automatic execution of the best next action may be performed within certain authorization parameters and beyond those parameters, the best next action recommendation may be provided to the customer for approval. The seeking of approval for automatic execution of the best next action is explained with reference to another illustrative example with reference to FIG. 4.

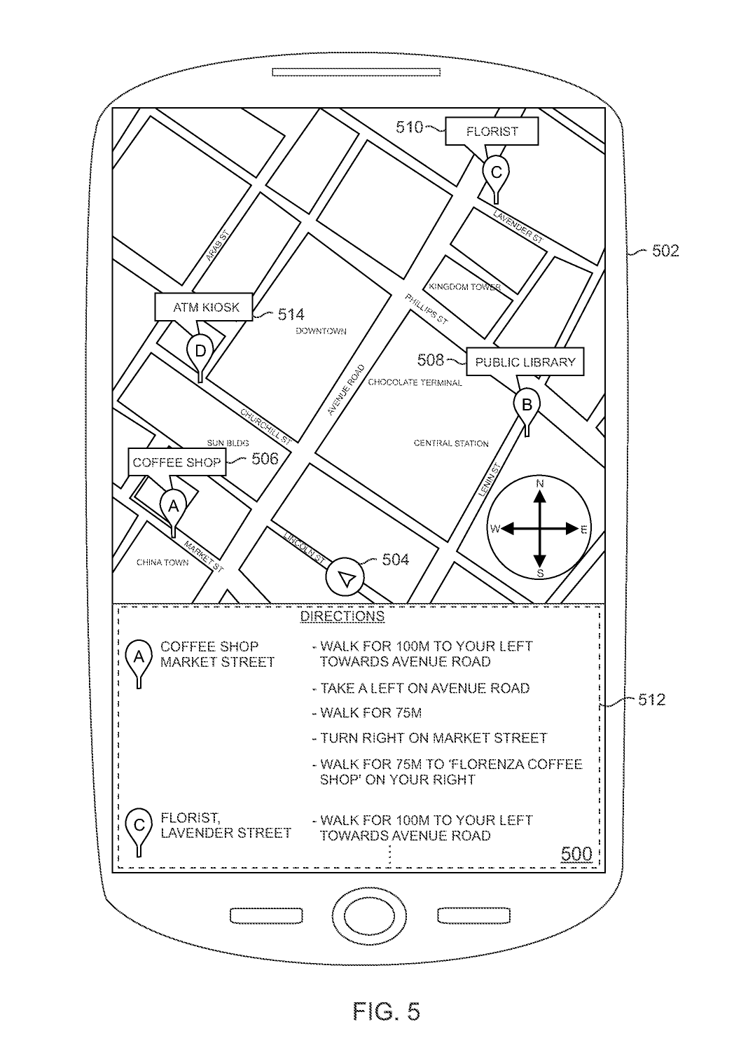

FIG. 4 shows an example user interface (UI) 400 displayed to a customer on a device 402 of the customer for seeking customer approval for effecting an automatic execution of a determined best next action, in accordance with an embodiment of the invention. In an example scenario, current information received corresponding to a customer may include information related to a current location of the customer. Further, the calendar information related to the customer may suggest that the customer is relatively free in the evening with no scheduled appointments. Moreover, general information gathered from one or more web servers may suggest that theatrical productions from ‘Cirque Du Soleil’ are currently performing shows in the same city (for example, Shanghai city) as the current location of the customer. The stored past information related to the customer may suggest that the customer is fond of Cirque du Soleil shows. In such an event, based on the current location of the customer and stored preferences, the system 200 may be caused to determine that the best next action may be to purchase tickets for an evening show. However, the system 200 may not be authorized to make such a transaction as the ticket cost is higher than a customer selected financial limit. In such a case, an approval to purchase tickets may be sought from the customer as exemplarily depicted in FIG. 4. More specifically, a notification 404 displaying a recommendation to purchase tickets may be provisioned to the customer on the device 402 of the customer. The notification 404 may further include two buttons 406 and 408 displaying text ‘Yes’ and ‘No’, respectively. Each of the buttons 406 and 408 is capable of receiving touch or click input indicative of customer approval and rejection, respectively. A customer may indicate her choice by selecting either one of the buttons 406 and 408. If the customer provides an approval for purchasing the show tickets, then the system 200 may be caused to utilize APIs, (such as for example, a digital wallet application) to effect automatic purchase of the show tickets. In some example embodiments, the determination of the best next action and its automatic execution thereof may include to and fro transport from the show venue. The determination of the best next action and its automatic execution is further explained with reference to another illustrative example in FIG. 5.

FIG. 5 shows a UI 500 displayed to a customer on a customer's device 502 for illustrating an example execution of a best next action, in accordance with an embodiment of the invention. In an illustrative example, a customer, whose schedule is usually over-full may unexpectedly have a 60-minute period of free time on account of a last minute cancellation of a meeting. Upon receiving information related to the meeting cancellation, for example, from a calendar application on the customer's device 502 (exemplarily depicted to be a mobile phone), the system 200 explained with reference to FIG. 2 may initiate determination of the best next action for the customer. In an example scenario, the determination of the best next action may involve determining the current location of the customer and the speed at which the customer is moving. For example, a current location of the customer can be determined using cell phone data, Wi-Fi triangulation, GPS, and such other technologies. Moreover, the speed at which the customer is moving may be determined based on the rate of change of the current location, and, the speed determined in such a manner may be used to predict whether the customer is riding in a vehicle, walking, stationary, etc. Further, the system 200 may utilize the stored past information of the customer to determine the best next action for the customer. For example, if the customer is a frequent visitor to a coffee shop, a habitual seeker of free Wi-Fi, or a regular customer at a florist shop, the determination of the best next action may include a visit to one of these locations. Accordingly, the system 200 in conjunction with a map API specific to the customer's device 502 may display a UI, such as the UI 500 depicting a map showing a current location of the customer at 504 and locations related to a branch of his/her favorite coffee shop, a public library offering free Wi-Fi access, a florist at 506, 508 and 510, respectively. Furthermore, the UI 500 includes a navigation section 512 offering detailed navigation to each of these locations from the current location 504 of the customer. In an embodiment, if the customer is determined to be active on another device, for example a tablet (not shown in FIG. 5), then the suggestion may be displayed on the tablet device.

In an embodiment, the system 200 may further consider additional information such as the customer's to-do list to determine the best next action. For example, the customer's to-do list can be examined and compared to the customer's current location 504 and current movement. In some example scenarios, the to-do list may be ranked in order of priority and importance of the items on the list. Accordingly, an item on the to-do list, while not of highest priority, may be attainable at a location nearby the current location 504 of the customer. The best next action that may be presented to the customer in such a scenario may include a recommendation to address the particular to-do item, travel time involved, a reminder of the next meeting time and location, and so on and so forth. For example, a lowly ranked item on the to-do list may involve withdrawing cash from an ATM Kiosk. However, since an ATM Kiosk (as exemplarily depicted at location 514) is located close to the current location 506 of the customer; the automatic execution of the best next action may include providing a suggestion to the customer that an ATM Kiosk is one block North West from the current location 504 of the customer.

Referring now to FIG. 2, in an example embodiment, the processor 202 is configured to, with the content of the memory 204, cause the system 200 to predict at least one intention of the customer based on the current information related to the customer. Moreover, the system 200 may be caused to determine the best next actions based on the predicted at least one intention. In an embodiment, the system 200 may be caused to predict a customer's intention (also referred to herein as intent) based on the customer's stored past information (for example, the profile data and the journey data) and on current information (predicted customer intent, current journey and the like). As explained above, the stored past information may include previous customer actions and responses including patterns in previous customer behavior, previous approvals made by the customer, prior customer journeys, etc. For example, if the current location information received from a customer's device is indicative of the customer being at a particular location (previously frequented by the customer), then the processor 202 of the system 200 may predict that the customer may visit a dentist in the vicinity of the current location based on the previously gathered information for the customer and her current location information. In another illustrative example, if sensor information from a car associated with the customer has relayed information to a customer device indicating that the car has been involved in an accident, then upon receiving such information from the customer device, the system 200 may identify the situation as an emergency situation and based on past customer actions predict that the customer may call a certain set of individuals/enterprises for seeking assistance.

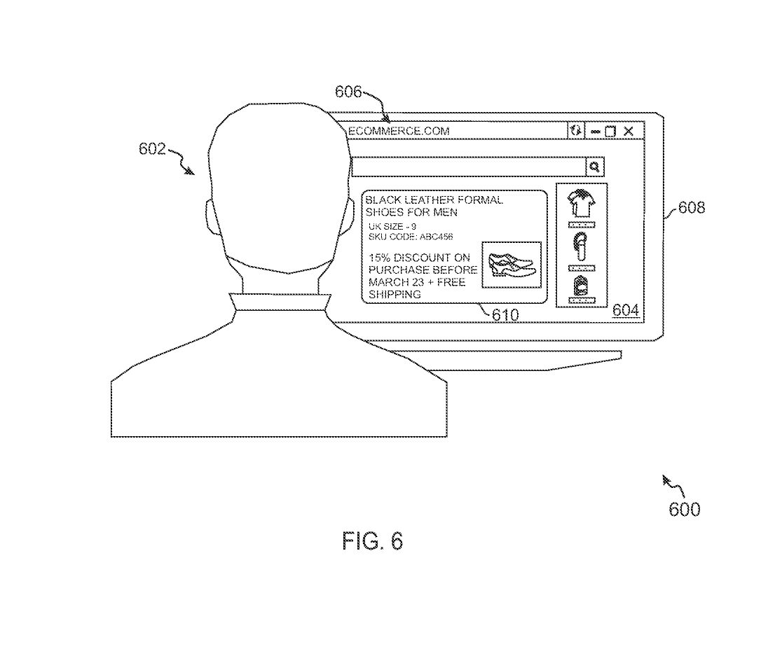

For such customer intention prediction purposes, the processor 202 of the system 200 may be configured to subject the stored past information in the memory 204 and the current information from one or more customer devices to a set of structured and un-structured data analytical models including text mining and predictive models (hereinafter collectively referred to as prediction models). In an embodiment, prior to subjecting the information to the prediction models, one or more sets of data may be appropriately transformed into signals/variables by the processor 202. In an illustrative example, location data of a customer (for example, GPS co-ordinates) may be transformed to derive how close the customer is to a store or a bank, to determine if the customer travels a lot or not (derived from all location data elements), to determine if the customer is driving or if the customer is indoors or outdoors, and the like. The prediction models may be configured to assign weight to these signals/variables such that possibility of error is minimized and/or likelihood of prediction being right is maximized. Further, the processor 202 may learn/adjust weights of prediction models using a feedback loop, wherein the processor 202 is configured to receive an outcome of the predictions at a later stage and then adjust the weights associated with the prediction models dynamically to account for observed errors. In an embodiment, the information may be transformed to generate a plurality of features (or feature vectors), which may then be provisioned to the prediction models for prediction purposes. Examples of the features that may be provisioned to the prediction models may include, but are not limited to, any combinations of words, features such as n-grams, unigrams, bigrams and trigrams, word phrases, part-of-speech of words, sentiment of words, sentiment of sentences, position of words, customer keyword searches, customer click data, customer web journeys, cross-channel journeys, call-flow, customer interaction history and the like. Examples of the prediction models may include, but are not limited to models based on Logistic regression, Naïve Bayesian, Rule Engines, Neural Networks, Decision Trees, Support Vector Machines, k-nearest neighbor, K-means and the like. In an embodiment, the processor 202 may be configured to extract features from information associated with each customer and provision the features to the prediction models. In an embodiment, the prediction models may utilize any combination of the above-mentioned input features to predict the customer's likely intents. In an example embodiment, the system 200 may be caused to provide one or more recommendations to the customer on the device based on the predicted at least one intention. An example recommendation provided to a customer based on the customer's predicted intent is explained with reference to an illustrative example in FIG. 6.

FIG. 6 shows an example recommendation provided to a customer 602 on an enterprise website 604, in accordance with an embodiment of the invention. In an illustrative example, the customer 602 may be browsing the enterprise website 604 using a browser application 606 on a customer device 608. Information related to ongoing web activity of the customer 602 may be provisioned to the I/O module 206 of the system 200 in substantially real-time, as current information. The received current information may include information such as web pages visited, sequence of web pages visited, time spent on each web page, content viewed on each web page etc. As explained with reference to FIG. 2, the received current information as well as stored past information of the customer may be subjected to transformation and further features may be generated from the transformed data. The feature vectors may be provided to prediction models, which may then predict at least one intention of the customer 602. In an illustrative example, the prediction models may predict 0.9 or a 90% probability of the customer 602 purchasing a pair of shoes. In such a case, the system 200 may be caused to provide one or more recommendations for assisting the customer 602 in purchasing the pair of shoes. For example, in the system 200 may be caused to display a self-help widget 610 on the enterprise website 604 displaying latest promotional offers on a brand of shoe preferred by the customer 602. In some example embodiments, the system 200 may also be caused to display pop-up ads offering discount coupons to the customer.

In an embodiment, the provisioning of the one or more recommendations may be based on corporate policy, for example, a policy to provide product and service information, to offer product and service incentives, and the like. In an embodiment, the provisioning of the one or more recommendations may be influenced by enterprise objectives. For example, the customer's profile data and journey data may be analyzed to determine the guidance and influence steps to be performed to keep the customer engaged or to facilitate consumption of goods/services by the customer. Enterprise objectives, such as keeping customer engaged or facilitating consumption of goods/services can be achieved by the guidance and influence steps which are not based on a fixed or standard support menu, but instead are predicted dynamically for the particular customer for example if, by analyzing customers profile customer, a more suitable channel is recommended for the interaction, then when an interaction on said channel is undertaken targeted information or assistance is provided to the customer based on the predicted intent. The determination of the best next action can be based on considering and evaluating some or all of the criteria mentioned above. In an embodiment, the best next action determined by the system 200 includes a plurality of steps. In an embodiment, the steps included in the best next action can be executed in a specific sequence, in parallel, or in a random manner.

In an embodiment, the system 200 may be configured to perform continuous adjustments to the predictions that are already made and/or even perform customization of the frameworks for predictions based on manual observational data associated with the customer responses to the predicted best next actions. Provision of customer support by anticipating customer needs and executing actions intuitively to meet those customer needs enable bringing about an improvement in customer experiences.

In an embodiment, the system 200 may further be configured to determine the best next action for the customer based on a predicted intent of the customer. In an embodiment, the determination of the best next action may be based on an analysis of the lowest effort sequence of tasks, interactions, and information that can get the customer to their intended goal. For the illustrative example explained with reference to FIG. 6, in an embodiment, the system 200 may be caused to determine the best next action to be purchase of a particular brand of shoes and, further effect an automatic purchase of the pair of shoes if such a next action meets preauthorized criteria related to financial transactions.

In some example embodiments, the system 200 may be configured to receive an instruction from the customer to revoke the execution of the automatically executed next action. In such a case, the system 200 may be caused to effect a reversal of the automatically executed next action in response to the instruction. For example, a notification, such as the email notification 302 explained with reference to FIG. 3, may be displayed to the customer. The notification may display text, such as for example—‘A pair of shoes of brand X has been purchased on your behalf. The cost of the shoes is charged to your credit card ending 5682’. Moreover, a button capable of being selected for ‘revoking’ or ‘undoing’ the purchase may also be displayed in the notification. The customer may select such an option to revoke the purchase. Thereafter a notification displaying text, such as ‘The purchase of shoes of brand X has been revoked. The amount will be credited to your account in next two working days’ may be provisioned to the customer.

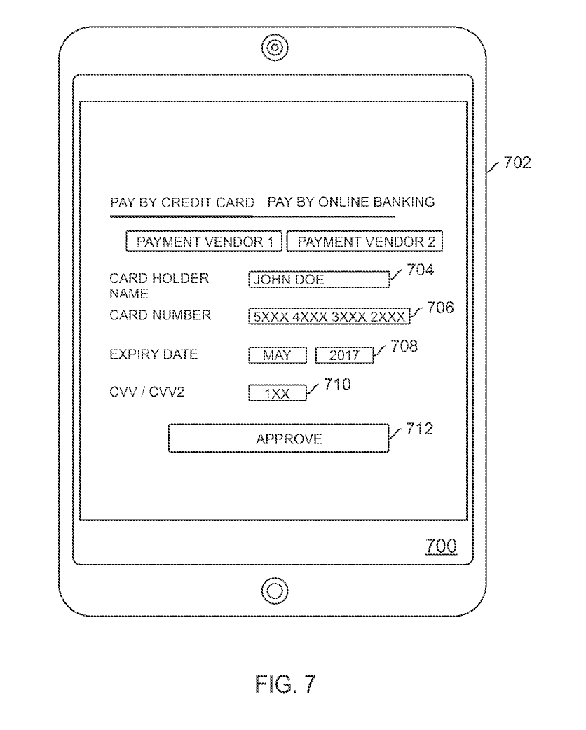

In an embodiment, the stored past information includes customer's account related credentials capable of facilitating an execution of a financial transaction. In an illustrative example, the customer's account may correspond to a credit card account. Accordingly, the account related credentials may include name of the customer as depicted on the card, card number, expiry date of the card, CVV (or CVV2) number and the like. In some embodiments, the system 200 is caused to automatically upload the customer's account related credentials for effecting an automatic execution of a financial transaction. An example uploading of the customer's account related credentials is explained with reference to an illustrative example in FIG. 7.

FIG. 7 shows a UI 700 displaying automatic uploading of a customer's credit card credentials for completing a purchase, in accordance with an embodiment of the invention. In an illustrative example, the current information received corresponding to the customer may indicate a bill payment that is due within next 24 hours. Moreover, the due amount associated with the bill may be in excess of the authorized amount for effecting an automatic execution. In such a case, the system 200 may be caused to seek an approval from the customer for paying of the bill. Additionally, the system 200 may be caused to determine the best next action to be paying the bill using a customer's credit card. For example, the customer may have used the credit card to pay several bills in the past. Moreover, the stored past information may also include the customer's credit card account credentials. Accordingly, in an embodiment, the system 200 may be caused to display a UI, such as the UI 700 on a customer's device 702 displaying form fields 704-710, such as those for card holder's name, card number, expiry date and CVV/CVV2 number. Moreover, the system 200 may be caused to pre-fill information in these form fields as exemplarily depicted in UI 700. The customer may provide a click or a touch input on a button 712 displaying text ‘Approve’ to effect the payment of the bill.

In some embodiments, the system 200 is caused to automatically update the customer's account related credentials upon receiving the current information, which includes information related to a profile update event performed by the customer. In an illustrative example, the customer may have updated a personal profile, such as for example updated birth date information, changed address information and/or contact information, added new email identification, changed a password or updated an answer to a secret question. In such a case, the system 200 may be caused to automatically update the customer's account related credentials accordingly. In some embodiments, the customer may be intimated of such a change through a notification and moreover the customer may revoke such an automatic updating of the account credentials if the customer so chooses.

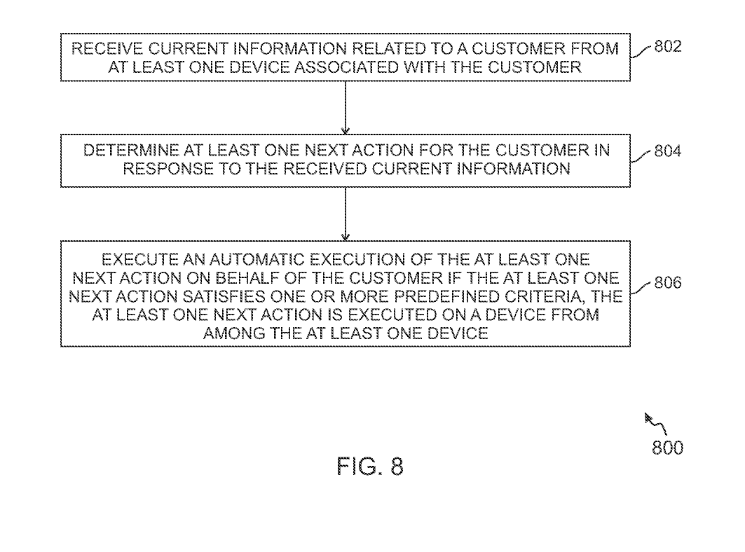

Such automatic uploading of the customer's account related credentials during a transaction or maintaining up-to-date account credentials precludes the need for the customer to fetch the card and manually input all the details in the various form fields, thereby improving customer's experiences. A method for improving customer's experiences is explained with reference to FIG. 8.

FIG. 8 is a flow diagram of an example method 800 for improving an experience of a customer, in accordance with an embodiment of the invention. The method 800 depicted in the flow diagram may be executed by, for example, the system 200 explained with reference to FIGS. 2 to 7. Operations of the flowchart, and combinations of operation in the flowchart, may be implemented by, for example, hardware, firmware, a processor, circuitry and/or a different device associated with the execution of software that includes one or more computer program instructions. The operations of the method 800 are described herein with help of the system 200. For example, one or more operations corresponding to the method 800 may be executed by a processor, such as the processor 202 of the system 200. It is noted that although the one or more operations are explained herein to be executed by the processor alone, it is understood that the processor is associated with a memory, such as the memory 204 of the system 200, which is configured to store machine executable instructions for facilitating the execution of the one or more operations. It is also noted that, the operations of the method 800 can be described and/or practiced by using a system other than the system 200. The method 800 starts at operation 802.

At operation 802 of the method 800, current information related to a customer is received from at least one device associated with the customer. Some non-limiting examples of the received current information related to the customer may include (1) current location of the customer; (2) web activity information including a log of activity of the customer on one or more websites being currently accessed by the customer; (3) device application information indicative of one or more applications being currently accessed by the customer on one or more devices of the customer; (4) calendar information comprising scheduled itinerary associated with the customer; (5) event occurrence information indicative of occurrence of an event related to the customer; and (6) interaction information including information related to a current interaction between a customer and a customer support representative (i.e. an agent). The various types of information that may be received corresponding to a customer are explained with reference to FIG. 2 and are not explained again, herein.

At operation 804 of the method 800, at least one next action is determined for the customer in response to the received current information. In an embodiment, the at least one next action is determined based on the current information and stored past information corresponding to the customer. As explained with reference to FIG. 2, the stored past information corresponding to the customer includes profile and journey data corresponding to the customer. More specifically, the stored past information corresponding to the customer is collated from across a plurality of interaction channels previously accessed by the customer for executing a plurality of actions, such as conducting a financial transaction, chatting with an agent, making a travel reservation, etc. Accordingly, the stored past information for a customer may include information such as recent financial transactions, history of bill payments, credit history, travel history, customer memberships, frequently visited websites, customer preferences and historical interactions with customer support representatives etc.

In an embodiment, at least one next action is determined based on one or more past actions of the customer retrieved from the stored past information based on their relevance to the current information. In some embodiments, relevant actions of customers associated with profiles similar to a profile of the customer may be identified and the at least one next action may be determined based on the identified actions. In an embodiment, a determined next action may correspond to at least one of rebooking a flight reservation, paying a bill, making a hotel reservation, making a car rental reservation, making a restaurant reservation, purchasing one or more tickets to an event, purchasing a product, initiating contact with an emergency service provider, seeking technical support, troubleshooting a concern, rescheduling one or more appointments, accessing a map location to search for one or more preferred locations near a current location of the customer and the like. In an embodiment, the next action may relate to a financial transaction, such as an action related to fraud prevention, proactive offer of payment splitting and/or payment rescheduling, credit card cancellation, sending a replacement credit card and so on and so forth.

The method ends at operation 806. At operation 806 of the method, an automatic execution of the at least one next action is executed on behalf of the customer if the at least one next action satisfies one or more predefined criteria. The at least one next action is executed on a customer device. The automatic execution of one or more next actions on the customer device may be facilitated through one or more APIs specific to the customer device. In an embodiment, a check may be performed to ascertain if the next action to be executed satisfies the one or more predefined criteria prior to its automatic execution of the device of the customer. For example, one criterion may relate to a requirement for a next action to be associated with an ability to be reversed upon execution. More specifically, the next action may be automatically executed on the device of the customer only if that action can be undone or reversed. In another illustrative example, a criterion may relate to a requirement for a next action to conform to at least one of a customer selected financial limit and a customer selected time limit if the next action corresponds to a financial transaction. More specifically, the customer may predefine certain limits and authorize actions to be performed if the next action conforms to those limits. The automatic execution of the at least one next action on the customer device may be performed as explained with reference to FIGS. 2 to 7 and is not explained again herein.

Without in any way limiting the scope, interpretation, or application of the claims appearing below, advantages of one or more of the exemplary embodiments disclosed herein suggest anticipating customer intents and provisioning services in an intuitive manner to improve customer experiences. More specifically, systems and methods disclosed herein suggest predicting best next action or actions for customers and thereafter automatically executing the actions thereby circumventing customer's wait for interaction support and also avoiding scripted interactions with customer support representatives or agents. Such intuitive provision of customer support precludes many frustrating and/or degrading aspects of conventional customer sales and service support and improves customer experiences thereby aiding in improving customer perception towards an enterprise with corresponding increase in customer loyalty and consumption.

Although the present technology has been described with reference to specific exemplary embodiments, it is noted that various modifications and changes may be made to these embodiments without departing from the broad spirit and scope of the present technology. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the systems and methods may be embodied using transistors, logic gates, and electrical circuits (for example, application specific integrated circuit (ASIC) circuitry and/or in Digital Signal Processor (DSP) circuitry).

Particularly, the system 200, the processor 202, the memory 204 and the I/O module 206 may be enabled using software and/or using transistors, logic gates, and electrical circuits (for example, integrated circuit circuitry such as ASIC circuitry). Various embodiments of the present technology may include one or more computer programs stored or otherwise embodied on a computer-readable medium, wherein the computer programs are configured to cause a processor or computer to perform one or more operations (for example, operations explained herein with reference to FIG. 8). A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (Blu-ray (registered trademark) Disc), and semiconductor memories (such as mask ROM, PROM (programmable ROM), EPROM (erasable PROM), flash ROM, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the present disclosure, as discussed above, may be practiced with steps and/or operations in a different order, and/or with hardware elements in configurations, which are different than those which, are disclosed. Therefore, although the technology has been described based upon these exemplary embodiments, it is noted that certain modifications, variations, and alternative constructions may be apparent and well within the spirit and scope of the technology.

Although various exemplary embodiments of the present technology are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method, comprising:
receiving, by a processor, current information related to a customer from at least one device associated with the customer;
determining, by the processor, at least one next action for the customer in response to the received current information, the at least one next action determined based on the current information and stored past information corresponding to the customer; and
effecting, by the processor, an automatic execution of the at least one next action on behalf of the customer if the at least one next action satisfies one or more predefined criteria, the at least one next action executed on a device from among the at least one device.

2. The method of claim 1, further comprising:
provisioning, by the processor, a message on the device for notifying the customer of the automatic execution of the at least one next action.

3. The method of claim 1, further comprising:
receiving, by the processor, an instruction from the customer to revoke the executed at least one next action; and
effecting, by the processor, a reversal of the execution of the at least one next action in response to the instruction.

4. The method of claim 1, further comprising:
requesting, by the processor, an approval from the customer for effecting the automatic execution of the at least one next action if the at least one next action does not satisfy the one or more predefined criteria, wherein the at least one next action is automatically executed on the device on behalf of the customer upon receiving the approval from the customer.

5. The method of claim 1, further comprising:
predicting, by the processor, at least one intention of the customer based on the current information related to the customer, wherein the at least one next action is determined at least in part based on the predicted at least one intention.

6. The method of claim 5, further comprising:
providing, by the processor, one or more recommendations to the customer on the device based on the predicted at least one intention.

7. The method of claim 1, wherein a criterion from among the one or more predefined criteria relates to a requirement for the at least one next action to be associated with an ability to be reversed upon execution.

8. The method of claim 1, wherein a criterion from among the one or more predefined criteria relates to a requirement for the at least one next action to conform to at least one of a customer selected financial limit and a customer selected time limit if the if the at least one next action corresponds to a financial transaction.

9. The method of claim 1, wherein the received current information related to the customer comprises at least one of:
current location of the customer;
web activity information comprising a log of activity of the customer on one or more websites being currently accessed by the customer;
device application information, the device application information indicative of one or more applications being currently accessed by the customer on the at least one device;
calendar information comprising scheduled itinerary associated with the customer;
event occurrence information indicative of occurrence of an event related to the customer; and
interaction information comprising information related to a current interaction between a customer and a customer support representative.

10. The method of claim 1, wherein the stored past information corresponding to the customer comprises information related to at least one of recent financial transactions, history of bill payments, credit history, travel history, customer memberships, frequently visited websites, customer preferences and historical interactions with customer support representatives.

11. The method of claim 10, wherein the stored past information corresponding to the customer is collated from across a plurality of interaction channels previously accessed by the customer on the at least one device for executing a plurality of actions.

12. The method of claim 1, wherein a next action from among the at least one next action corresponds to at least one of rebooking a flight reservation, paying a bill, making a hotel reservation, making a car rental reservation, making a restaurant reservation, purchasing one or more tickets to an event, purchasing a product, initiating contact with an emergency service provider, seeking technical support, troubleshooting a concern, rescheduling one or more appointments, accessing a map location to search for one or more preferred locations near a current location of the customer, canceling a credit card and requesting a replacement credit card.

13. The method of claim 1, wherein the at least one next action is determined based on at least one of:
one or more past actions of the customer, the one or more past actions of the customer retrieved from the stored past information based on a relevance of the one or more past actions to the current information; and
actions of customers associated with profiles similar to a profile of the customer, the actions of the customers identified based on a respective relevance of the actions to the current information.

14. The method of claim 1, wherein the stored past information comprises customer's account related credentials capable of facilitating an automatic execution of a financial transaction.

15. The method of claim 14, wherein the customer's account related credentials are automatically uploaded by the processor for effecting the automatic execution of the financial transaction.

16. The method of claim 14, wherein the customer's account related credentials are automatically updated, by the processor, upon receiving the current information comprising information related to a profile update event effected by the customer.

17. The method of claim 1, wherein the at least one next action is determined from among a plurality of probable actions capable of being performed for the customer, the at least one next action most suited to be executed in response to the received current information.

18. A system, comprising:
at least one processor; and
a memory having stored therein machine executable instructions, that when executed by the at least one processor, cause the system to:
receive current information related to a customer from at least one device associated with the customer;
determine at least one next action for the customer in response to the received current information, the at least one next action determined based on the current information and stored past information corresponding to the customer; and
effect an automatic execution of the at least one next action on behalf of the customer if the at least one next action satisfies one or more predefined criteria, the at least one next action executed on a device from among the at least one device.

19. The system of claim 18, wherein the system is further caused to:
provision a message on the device for notifying the customer of the automatic execution of the at least one next action.

20. The system of claim 18, wherein the system is further caused to:
receive an instruction from the customer to revoke the executed at least one next action; and
effect a reversal of the execution of at least one next action in response to the instruction.

21. The system of claim 18, wherein the system is further caused to:
request an approval from the customer for effecting the automatic execution of the at least one next action if the at least one next action does not satisfy the one or more predefined criteria, wherein the at least one next action is automatically executed on the device on behalf of the customer upon receiving the approval from the customer.

22. The system of claim 18, wherein the system is further caused to:
predict at least one intention of the customer based on the current information related to the customer, wherein the at least one next action is determined based on the predicted at least one intention.

23. The system of claim 22, wherein the system is further caused to:
provide one or more recommendations to the customer on the device based on the predicted at least one intention.

24. The system of claim 18, wherein a criterion from among the one or more predefined criteria relates to a requirement for the at least one next action to be associated with an ability to be reversed upon execution.

25. The system of claim 18, wherein a criterion from among the one or more predefined criteria relates to a requirement for the at least one next action to conform to at least one of a customer selected financial limit and a customer selected time limit if the at least one next action corresponds to a financial transaction.

26. The system of claim 18, wherein a next action from among the at least one next action corresponds to at least one of rebooking a flight reservation, paying a bill, making a hotel reservation, making a car rental reservation, making a restaurant reservation, purchasing one or more tickets to an event, purchasing a product, initiating contact with an emergency service provider, seeking technical support, troubleshooting a concern, rescheduling one or more appointments, accessing a map location to search for one or more preferred locations near a current location of the customer, canceling a credit card and requesting a replacement credit card.

27. The system of claim 18, wherein the at least one next action is determined based on at least one of:
one or more past actions of the customer, the one or more past actions of the customer retrieved from the stored past information based on a relevance of the one or more past actions to the current information; and
actions of customers associated with profiles similar to a profile of the customer, the actions of the customers identified based on a respective relevance of the actions to the current information.

28. The system of claim 18, wherein the stored past information comprises customer's account related credentials capable of facilitating an automatic execution of a financial transaction.

29. The system of claim 28, wherein the system is further caused to automatically upload the customer's account related credentials for effecting the automatic execution of the financial transaction.

30. The system of claim 28, wherein the system is further caused to automatically update the customer's account related credentials upon receiving the current information comprising information related to a profile update event effected by the customer.
